(19) United States
(12) Patent Application Publication
(10) Pub. No.: US 2024/0071742 A1
(43) Pub. Date: Feb. 29, 2024

(54) TWO FREQUENCY ION TRAP PERFORMANCE

(71) Applicant: Thermo Finnigan LLC, San Jose, CA (US)

(72) Inventors: Christopher Mullen, Menlo Park, CA (US); John Syka, San Jose, CA (US)

(21) Appl. No.: 18/455,356

(22) Filed: Aug. 24, 2023

Related U.S. Application Data
(60) Provisional application No. 63/401,074, filed on Aug. 25, 2022.

(51) Int. Cl. H01J 49/42; H01J 49/02

(52) U.S. Cl. CPC H01J 49/429; H01J 49/025; H01J 49/4225

(57) ABSTRACT

This system and method disclosed herein are configured to improve high mass range ion trap performance by use of a multi-directional segmented scan approach. In some embodiments of the system and method disclosed herein, the mass range of conventional ion trap technology may be extended/increased without changing the hardware or compromising lower range mass/charge efficiency. Specifically, the system and methods disclosed herein use a segmented, bi-directional scan that increases the mass range of an ion trap mass spectrometer and circumvents the problem of mass discrimination during mass analysis in the high Thompson value range.

### BACKGROUND

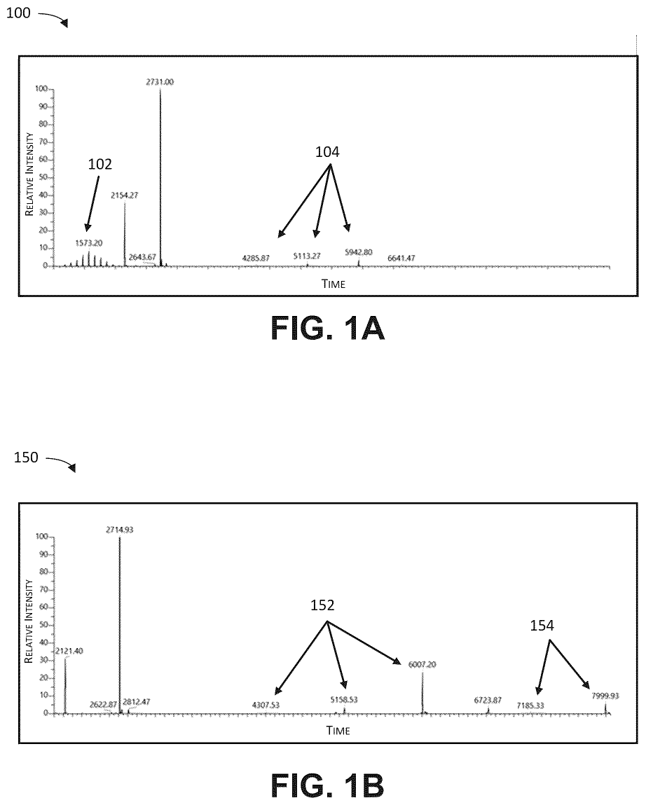

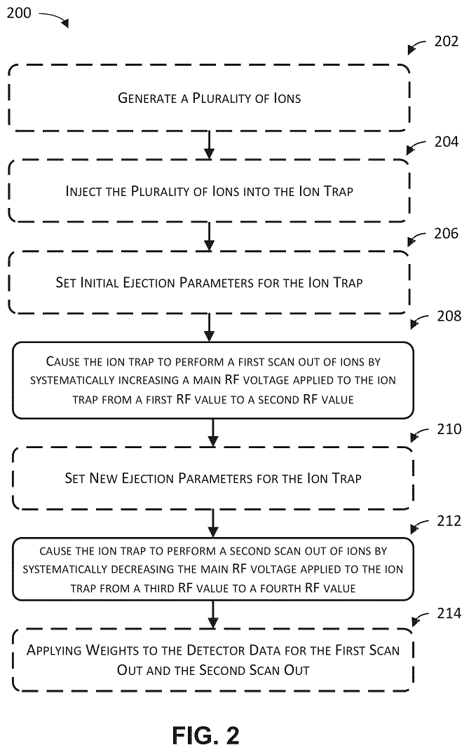

In the field of mass spectrometry, current ion trap systems have limited mass ranges within which they can optimally perform. For example, when prior art ion traps are used to continuously scan out ions having a wide range of Thompson values, these prior art ion traps suffer from a high degree of ion discrimination. An example of this discrimination is shown in FIGS. 1A and 1B, which are relative intensity graphs of mass spectrometry analysis of an Ultramark® Mass Spec standard that were obtained using a first continuous scan across a Thompson value range of 1000-10000 Thompson value (FIG. 1A) and a second continuous scan across a Thompson value range of 2000-10000 Thompson value (FIG. 2A). As shown in graph 100, while the first scan was able to capture many ion species 102 within the 1000-2000 Thompson value range, graph 100 shows a reduced detection rate of ion species 104 within the 4000-7000 Thompson value range and an absence of any ions detected within the 7000-10000 Thompson value range. By comparison, FIG. 1B shows a graph 150 of a mass spectrometry analysis of the same standard but with a higher bottom Thompson value range of the continuous scan. As can be seen in FIG. 1B, this second scan has an increased detection rate of ion species 152 within the 4000-7000 Thompson value range and includes the data for ions species 154 within the 7000-10000 Thompson value range that were completely lost in the first scan.

As the field of mass spectrometry evolves, it is desired that mass spectrometry systems be capable of analyzing or otherwise handling samples having wider ranges of Thompson value values without losing resolution or suffering from discrimination of high Thompson value ion species.

### SUMMARY OF THE INVENTION

This system and method disclosed herein are configured to improve high mass range ion trap performance by use of a multi-directional segmented scan approach. In some embodiments of the system and method disclosed herein, the mass range of conventional ion trap technology may be extended/increased without changing the hardware or compromising lower range mass/charge efficiency. Specifically, the system and methods disclosed herein use a segmented, bi-directional scan that increases the mass range of an ion trap mass spectrometer and circumvents the problem of mass discrimination during mass analysis in the high Thompson value range.

FIG. 2 shows an example embodiment of a method 200 according to the present disclosure. In the method of FIG. 2, a plurality of ions are generated and injected into an ion trap. Initial ejection parameters of the ion trap are optionally set, and then ion trap is caused to perform a first scan out of ions by systematically increasing the main RF voltage applied to the ion trap from a first RF value to a second RF value. Then, new ejection parameters of the ion trap are optionally set, and then ion trap is caused to perform a second scan out of ions by systematically decreasing the main RF voltage applied to the ion trap from a third RF value to a fourth RF value. By utilizing this segmented, bi-directional scanning, the method 200 is able to obtain mass spectrometry analysis for ion populations containing ion species having wide range of Thompson values with reduced discrimination against high Thompson value species. In some embodiments, weight may further be applied to the detector data for each scan to account for the expected ejection efficiency for each scan.

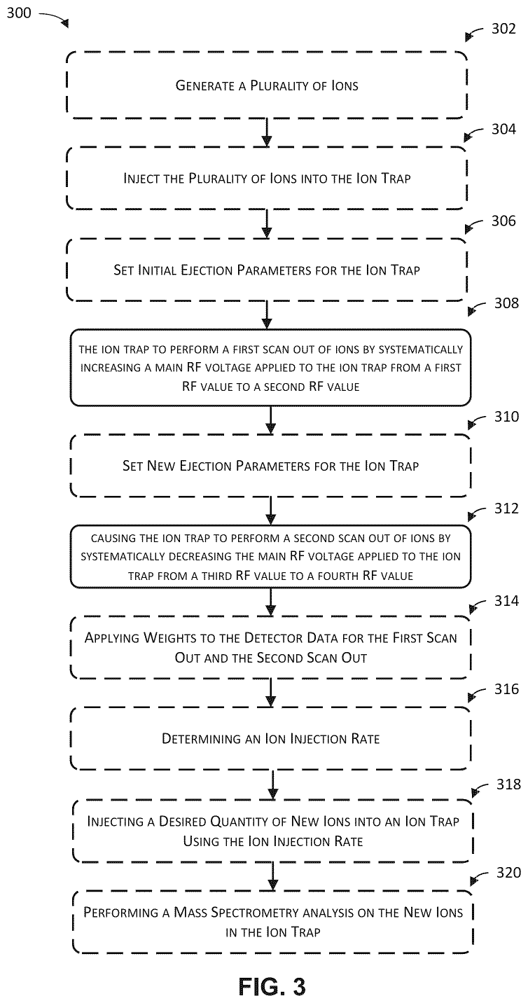

FIG. 3 shows an example process 300 where the system and method of the present disclosure is incorporated into a pre-scan procedure. Ion traps operate optimally when they contain a particular quantity of ion charge, with different ion traps being designed to optimally handle different quantities of ions. However, the rate delivery to and injection into an ion trap may vary over a large range because sample abundance may vary strongly with time such as when the sample delivery system is a liquid chromatograph. There are a variety of methods in the art to optimally control injection processes to ensure a near optimal quantity of ion charge to be injected in the ion trap for it to properly perform. Such schemes are most commonly referred to in the art as Automatic Gain Control, AGC. On widely used approach of performing AGC is to perform a “pre scan” experiment to determine the rate of ion accumulation in ion trap when ions are gated in and follow up with a second “analytical scan” experiment wherein the ion injection time is determined based on an estimation of the ion accumulation rate determined from the pre scan experiment so as to have a near optimal population of the ion trap. The results from that experiment are the ones generally recorded as analytical data.

FIG. 3 shows an example method where the segmented, bi-directional scan process shown in FIG. 2 is incorporated as a pre-scan experiment. As shown in FIG. 3, the quantity of ions determined in the method of FIG. 2 can be used to determine the injection rate of ions into the ion trap (e.g., by dividing the determined quantity of ion charge by the amount of time that ions were allowed to pass into the ion trap). This injection rate of ions can then be used to determine the amount of time that ions should be allowed to flow into the ion trap (the same ion trap or a different ion trap) to ensure that the optimal quantity of ions are within the ion trap. In FIGS. 2 and 3, steps that are optional are shown having dashed outlines.

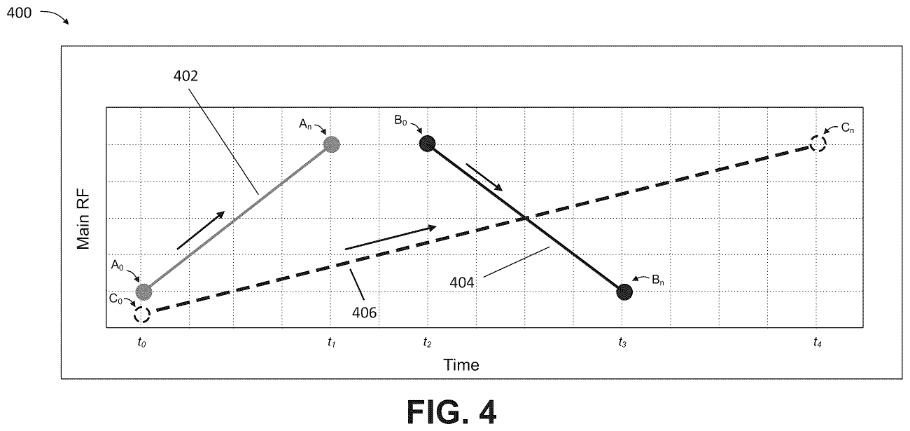

FIG. 4 shows a graphical representation 400 of the segmented, bi-directional scan process of the present disclosure. Specifically, graph 400 shows a first scan segment 402 in which the main RF voltage is increased from A₀ to Aₙ during the time period t₀-t₁, and a second scan segment 404 in which the main RF voltage is decreased from B₀ to Bₙ during the time period t₂-t₃. In this way, by adjusting the ejection parameters between the two scans (e.g., changing the frequency of auxiliary AC between the two scans), the species of ions that are ejected during the two concatenated scans can be different. For example, increasing the main RF from A₀ to Aₙ may cause the m/z sequential ejection of ion species starting at a m/z of 1000 Th (Th, Thompson is a proposed unit of for m/z—Daltons/number of elementary charges) and up to m/z 2000 Th to be ejected from the ion trap. In some embodiments, increasing the main RF voltage from A₀ to Aₙ may correspond to increasing the main RF voltage on the system so that it is equal to or close to the maximum magnitude of main RF voltage that is permitted to apply. Similarly, decreasing the main RF voltage from B₀ to Bₙ may cause the m/z sequential ejection of trapped ion species starting from a m/z of 16000 Th down to 2000 Thompsons. In some embodiments, decreasing the main RF from B₀ to Bₙ may correspond to decreasing the main RF voltage on the system from close to the maximum magnitude of main RF voltage the ion trap can handle to a lower RF value. Graph 400 also shows the prior art process 406 where, RF voltage would be ramped while using the auxiliary AC frequency of the second scan from C₀ to Cₙ over time period t₀-t₄, which theoretically should scan out ions m/z sequentially from a m/z of 1000 Th to a m/z of 16,000 Th. However, this results in a high discrimination against the retention and thus detection of high m/z ion species because the initial main RF Voltage, C₀, is too low to effect radial confinement of the high m/z ions with near thermal kinetic energies. This effect is exacerbated by having moderate levels of low or intermediate m/z ions in the trap as their space charge will radially destabilize the high m/z ions leading to a further reduction the practical upper m/z limit for ion confinement at the initial RF Voltage, C₀ The new method allows the initial main RF voltage, A₀, to be twice that of the initial RF Voltage.

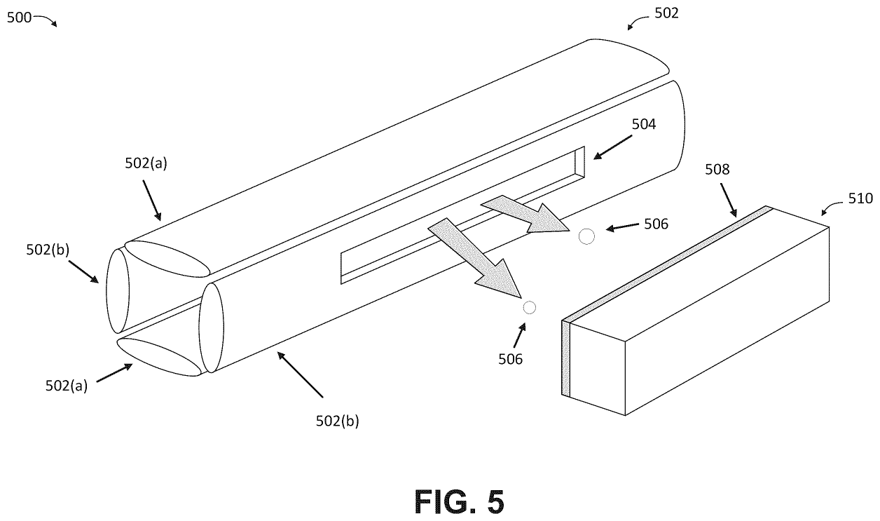

FIG. 5 illustrates an example system 500 comprising an ion trap 502 composed of parallel sets of electrodes 502(a) and 502(b). As understood in the art, linear ion traps may include a slit 504 that allows ions 506 to be ejected from the ion trap when they achieve resonance. FIG. 5 further shows how the ejected ions may be detected by a detector system 510 when they are incident on a detection surface 508.

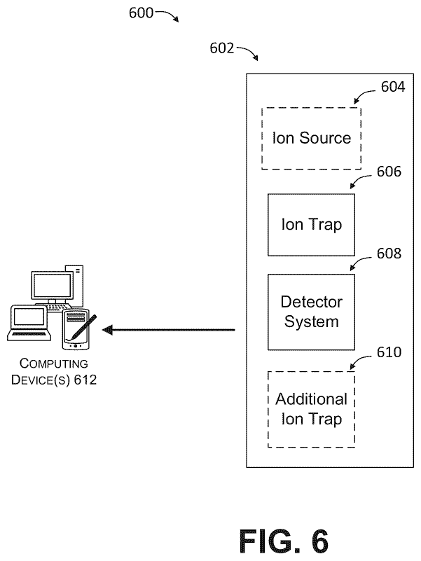

FIG. 6 shows an environment 600 for practicing the systems and methods of the present disclosure. Environment 600 shows a mass spectrometer 602 comprising an ion source 604, and ion trap 606, a detector system 608, and an optional additional ion trap 610. FIG. 6 further shows computing devices 612 as being separate from the mass spectrometer 602. However, a person having skill in the art would understand the computing devices 612 may be incorporated in whole or in part into the mass spectrometer 602.

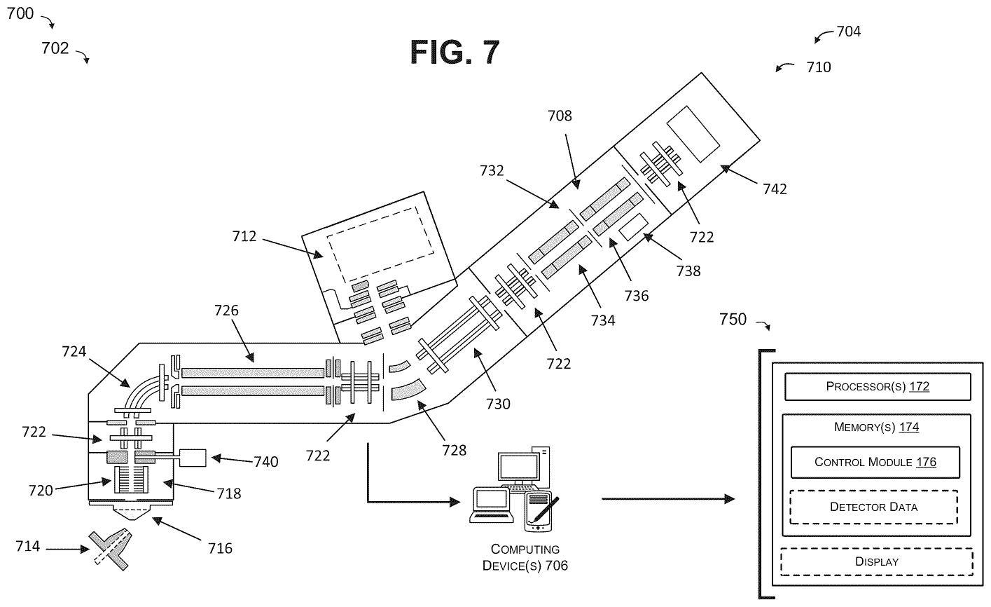

FIG. 7 illustrates example environments 700 for improving high mass range ion trap performance by use of a multi-directional segmented scan approach. Specifically, FIG. 7 shows an example environment 702 that includes an example mass spectrometer system 704 for complex mass spectrometry experiments and measurements using low Mathieu q dissociation of precursor ions, and computing devices 706 configured to control the operation of the mass spectrometer system 704 and/or perform post processing on detector data generated therefrom. It is noted that present disclosure is not limited to environments that include mass spectrometers, and that in some embodiments the environments 700 may include a different type of system that is configured to manipulate and/or otherwise examine ions within an ion trap, or may only include the computing devices 706.

The example mass spectrometer system 704 may be or include one or more different types of mass spectrometers known in the art that comprise an ion trap 708 configured to allow for the dissociation of precursor ions (e.g., RF quadrupole ion trap devices, etc.).

FIG. 7 shows the example microscope system(s) 704 as being a hybrid mass spectrometer 710, comprising more than one type of mass analyzer. Specifically, the mass spectrometer system 710 includes a quadrupole ion trap mass analyzer 708 as well as an electrostatic trap mass analyzer 712 (e.g., ORBITRAP™ analyzer). However, it is understood that different combinations of mass analyzers are desirous for different applications, and thus according to the present disclosure example microscope systems 704 may include a fewer or greater number of mass analyzers and/or comprise different combinations of mass analyzers.

In operation of the example mass spectrometer system 710, an electrospray ion source 714 provides ions of a sample to be analyzed to an aperture of a heated ion transfer tube 716, at which point the ions enter into a first vacuum chamber 718. After entry, the ions are captured and focused into a tight beam by an ion collimating device 720 (e.g., a stacked-ring ion guide, an ion lens, an ion funnel, etc.). The example spectrometer 710 is further shows as including a plurality of ion optical transfer components 722 that are configured to allow ions to pass between intermediate-vacuum regions of the mass spectrometer during travel. Example spectrometer 710 is illustrated as including a curved beam guide 724 that separates most remaining neutral molecules and undesirable ion clusters (e.g., solvated ions, environmental contaminants, etc.) from the ion beam. For example, neutral molecules and ion clusters follow a straight-line path whereas the paths of ions of interest are bent around the ninety-degree turn of the curved beam guide 724, thereby producing the separation.

A quadrupole mass filter 726 of the mass spectrometer system 710 is used in its conventional sense as a tunable mass filter so as to pass ions only within a selected m/z range. A subsequent ion optical transfer component 722 delivers the filtered ions to a curved ion trap (“C-trap”) component 728. The C-trap 728 is able to transfer ions along a pathway between the quadrupole mass filter 726 and the ion trap mass analyzer 708. The C-trap 728 also has the capability to temporarily collect and store a population of ions and then deliver the ions, as a pulse or packet, into the mass analyzer 712.

FIG. 7 further shows a multipole ion guide 730 and an optical transfer component 722 as serving to guide ions between the C-trap 728 and the ion trap mass analyzer 708. The multipole ion guide 730 may provide temporary ion storage capability such that ions produced in a first processing step of an analysis method can be later retrieved for processing in a subsequent step. The multipole ion guide 730 may also serve as a fragmentation cell and ion trap (i.e., an ion routing multipole). Various ion optics along the pathway between the C-trap 728 and the ion trap mass analyzer 708 may be controllable such that ions may be transferred in either direction, depending upon the sequence of ion processing steps required in a particular analysis method.

The ion trap mass analyzer 708 is illustrated in FIG. 7 as being a dual-pressure linear ion trap 732 (i.e., a two-dimensional trap) comprising a high-pressure linear trap cell 734 and a low-pressure linear trap cell 736, the two cells being positioned adjacent to one another and separated by a plate lens having a small aperture that permits ion transfer between the two cells and that also acts as a pumping restriction that allows different pressures to be maintained in the two traps. However, a person having skill in the art would understand that other types of ion traps 708 are capable of performing the multi-directional segmented scan approach disclosed herein, and thus may be used according to the present disclosure.

The environment of the high-pressure cell 734 favors ion trapping, ion cooling, ion fragmentation by either collision-induced dissociation or pulsed-q dissociation, ion/ion reactions by either electron transfer dissociation or proton-transfer reactions, and some types of photon activation, such as ultraviolet photo dissociation (UVPD). The environment of the low-pressure cell 736 favors analytical scanning with high resolving power and mass accuracy. The ion trap 708 further is shown as including an ion detector 738 (e.g., a dual-dynode ion detector).

The use of either electron transfer dissociation or a proton transfer reaction, within a mass analysis method, requires the capability of performing controlled ion-ion reactions within a mass spectrometer. Ion-ion reactions, in turn, require the capabilities of generating reagent ions, and of causing the reagent ions to mix with sample ions. The example mass spectrometer system 110 is depicted as including a reagent-ion source 740 disposed between the stacked-ring ion guide 120 and the curved beam guide 724. However, within the present disclosure one or more additional reagent-ion sources may be included in an example mass spectrometer system 704. FIG. 7 further illustrates the example spectrometer 710 as including one or more additional components 742. Such additional components may include various combinations of one or more ion guides, ion traps, lenses, detectors, reagent ion sources, etc. A person having skill in the art would appreciate that example spectrometer 710 is merely an example configuration of a system capable of enabling/performing the system and methods for low Mathieu q dissociation of precursor ions disclosed herein.

The environment 700 is also shown as including one or more computing device(s) 706. Those skilled in the art will appreciate that the computing devices 706 depicted in FIG. 7 are merely illustrative and are not intended to limit the scope of the present disclosure. The computing system and devices may include any combination of hardware or software that can perform the indicated functions, including computers, network devices, internet appliances, PDAs, wireless phones, controllers, oscilloscopes, amplifiers, etc. The computing devices 706 may also be connected to other devices that are not illustrated, or instead may operate as a stand-alone system.

It is also noted that one or more of the computing device(s) 706 may be a component of the example mass spectrometers 704, may be a separate device from the example mass spectrometers 704 which is in communication with the example mass spectrometers 704 via a network communication interface, or a combination thereof. For example, an example mass spectrometers 704 may include a first computing device 706 that is a component portion of the example mass spectrometers 704, and which acts as a controller that drives the operation of the example mass spectrometers 704 (e.g., adjust the scanning location on the sample by operating the scan coils, etc.). In such an embodiment the example mass spectrometers 704 may also include a second computing device 706 that is a desktop computer separate from the example microscope system(s) 704, and which is executable to process data received from the detector system 738 to generate representations of the spectra based on the detector data (e.g., chromatograms, extracted ion current (EIC) profiles, etc.) and/or perform other types of analysis or post-processing of the detector data. The computing devices 706 may further be configured to receive user selections via a keyboard, mouse, touchpad, touchscreen, wireless devices, other user interface, etc.

Additionally, the computing device(s) 706 are configured to control the example mass spectrometers 704 to allow for the performance a mass spectrometry analysis on a sample. For example, one or more user selections, an automation program, or a combination thereof may allow the computing devices 710 to cause mass spectrometers 704 and/or components thereof to perform any of the methods described in the present disclosure, including those described in the Enumerated Paragraphs, and using any of the parameters described herein or which are widely understood by persons having skill in the art as being part of performing such methods.

User selections, an automation program, or a combination thereof may then cause the computing devices 710 to generate analyze detector data from the mass spectrometers 704 relating to a sample, and/or create one or more chromatograms associated with the performed mass spectroscopy analysis of the samples.

FIG. 1 further includes a schematic diagram illustrating an example computing architecture 750 of the computing devices 705. Example computing architecture 750 illustrates additional details of hardware and software components that can be used to implement the techniques described in the present disclosure. Persons having skill in the art would understand that the computing architecture 750 may be implemented in a single computing device 706 or may be implemented across multiple computing devices. For example, individual modules and/or data constructs depicted in computing architecture 750 may be executed by and/or stored on different computing devices 706. In this way, different process steps of the inventive methods disclosed herein may be executed and/or performed by separate computing devices 706 and in various orders within the scope of the present disclosure. In other words, the functionality provided by the illustrated components may in some implementations be combined in fewer components or distributed in additional components. Similarly, in some implementations, the functionality of some of the illustrated components may not be provided and/or other additional functionality may be available.

In the example computing architecture 750, the computing device includes one or more processors 752 and memory 754 communicatively coupled to the one or more processors 152. While not intended to be limiting, example computing architecture 750 is shown as including a control module 766 stored in the memory 754. As used herein, the term “module” is intended to represent example divisions of executable instructions for purposes of discussion and is not intended to represent any type of requirement or required method, manner, or organization. Accordingly, while various “modules” are described, their functionality and/or similar functionality could be arranged differently (e.g., combined into a fewer number of modules, broken into a larger number of modules, etc.). Further, while certain functions and modules are described herein as being implemented by software and/or firmware executable on a processor, in other instances, any or all of modules can be implemented in whole or in part by hardware (e.g., a specialized processing unit, etc.) to execute the described functions. As discussed above in various implementations, the modules described herein in association with the example computing architecture 750 can be executed across multiple computing devices 706.

The control module 768 can be executable by the processors 752 to cause a computing device 710 and/or example mass spectrometers 704 to take one or more actions and/or perform functions or maintenance of the systems. In some embodiments, the control module 768 may cause the example mass spectrometers 704 to perform a mass spectrometry analysis on a sample. More specifically, according to the present disclosure, the example control module 768 can be executable to cause mass spectrometers 704 and/or components thereof to perform any of the methods described in the present disclosure, including those described in the Enumerated Paragraphs, and using any of the parameters described herein or which are widely understood by persons having skill in the art as being part of performing such methods.

As discussed above, the computing devices 706 include one or more processors 752 configured to execute instructions, applications, or programs stored in a memory(s) 754 accessible to the one or more processors. In some examples, the one or more processors 752 may include hardware processors that include, without limitation, a hardware central processing unit (CPU), a graphics processing unit (GPU), and so on. While in many instances the techniques are described herein as being performed by the one or more processors 752, in some instances the techniques may be implemented by one or more hardware logic components, such as a field programmable gate array (FPGA), a complex programmable logic device (CPLD), an application specific integrated circuit (ASIC), a system-on-chip (SoC), or a combination thereof.

The memories 754 accessible to the one or more processors 752 are examples of computer-readable media. Computer-readable media may include two types of computer-readable media, namely computer storage media and communication media. Computer storage media may include volatile and non-volatile, removable, and non-removable media implemented in any method or technology for storage of information, such as computer readable instructions, data structures, program modules, or other data. Computer storage media includes, but is not limited to, random access memory (RAM), read-only memory (ROM), erasable programmable read only memory (EEPROM), flash memory or other memory technology, compact disc read-only memory (CD-ROM), digital versatile disk (DVD), or other optical storage, magnetic cassettes, magnetic tape, magnetic disk storage or other magnetic storage devices, or any other non-transmission medium that may be used to store the desired information and which may be accessed by a computing device. In general, computer storage media may include computer executable instructions that, when executed by one or more processing units, cause various functions and/or operations described herein to be performed. In contrast, communication media embodies computer-readable instructions, data structures, program modules, or other data in a modulated data signal, such as a carrier wave, or other transmission mechanism. As defined herein, computer storage media does not include communication media.

Those skilled in the art will also appreciate that items or portions thereof may be transferred between memory 754 and other storage devices for purposes of memory management and data integrity. Alternatively, in other implementations, some or all the software components may execute in memory on another device and communicate with the computing devices 706. Some or all of the system components or data structures may also be stored (e.g., as instructions or structured data) on a non-transitory, computer accessible medium or a portable article to be read by an appropriate drive, various examples of which are described above. In some implementations, instructions stored on a computer-accessible medium separate from the computing devices 706 may be transmitted to the computing devices 706 via transmission media or signals such as electrical, electromagnetic, or digital signals, conveyed via a communication medium such as a wireless link. Various implementations may further include receiving, sending, or storing instructions and/or data implemented in accordance with the foregoing description upon a computer-accessible medium.

Examples of inventive subject matter according to the present disclosure are descry bed in the following enumerated paragraphs.

A1. A method for extending the mass range of an ion trap while reducing mass discrimination, the method comprising: causing the ion trap to perform a first scan out of ions by systematically increasing a main RF voltage applied to the ion trap from a first RF value to a second RF value; and causing the ion trap to perform a second scan out of ions by systematically decreasing the main RF voltage applied to the ion trap from a third RF value to a fourth RF value.

A1.1. The method of paragraph A1, further comprising: before the first scan is performed, setting one or more initial ejection parameters for the ion trap; and between the performance of the first scan and the second scan, setting one or more new ejection parameters for the ion trap.

A1.1.1. The method of paragraph A1.1, wherein setting the one or more ejection parameters comprises applying an auxiliary RF of a first auxiliary value to the ion trap.

A1.1.2. The method of any of paragraphs A1.1 or A1.1.1, wherein setting the one or more new ejection parameters comprises changing the auxiliary RF applied to the ion trap to a second auxiliary value.

A1.2. The method of any of paragraphs A1-A1.1.2, wherein the second RF value is greater than the first RF value.

A1.2.1. The method of any of paragraphs A1-A2.1, wherein the third RF value is greater than the first RF fourth.

A1.2.2. The method of any of paragraphs A1-A2.1, wherein the second RF value corresponds to equal to or greater than 50%, 60%, 75%, 80%, 90%, 95%, and 98% of the maximum of main RF voltage the ion trap can handle.

A1.2.3. The method of any of paragraphs A1-A2.2, wherein the third RF value corresponds to equal to or greater than 50%, 60%, 75%, 80%, 90%, 95%, and 98% of the maximum of main RF voltage the ion trap can handle.

A1.3. The method of any of paragraphs A1-A1.2.3, wherein the r0, the maximum main RF voltage, and main RF frequency of the ion trap are not changed between the first scan and the second scan.

A1.4. The method of any of paragraphs A1-A1.3, wherein the resonance ejection frequency is a first frequency value during the first scan out and a second frequency value during the second scan out.

A1.4.1. The method of paragraph A1.4, wherein the resonance ejection frequency is essentially the same between the first scan and the second scan.

A1.4.2. The method of paragraph A1.4, wherein the first frequency value is different from the second frequency value.

A1.4.2.1. The method of paragraph A1.4.2, wherein the first frequency value is greater than the second frequency value.

A1.4.2.2. The method of any of paragraphs A1.4-A1.4.2, wherein the first frequency value and the second frequency value are determined or otherwise selected such that ions having a first desired Thompson value are ejected from the ion trap during the first scan out and ions having a second desired Thompson value are ejected from the ion trap during the second scan out.

A1.5. The method of any of paragraphs A1-A1.4.2.2, wherein the first scan out of ions and the second scan out of ions are each performed on a population of ions injected during a single ion injection cycle.

A1.5.1. The method of paragraph A1.5, wherein the single ion injection cycle comprises: allowing the population of ions to pass into the ion trap; closing the ion trap so as to contain the population of ions in the ion trap.

A1.5.1.1. The method of paragraph 1.5.1, wherein the first scan out of ions and the second scan out of ions are each performed after the ion trap is closed.

A1.5.2. The method of any of paragraphs A1.5-1.5.1.1, wherein no additional ions are injected or otherwise intentionally introduced into the ion trap between the first scan out of ions and the second scan out of ions.

A1.6. The method of any of paragraphs A1-A1.5.2, wherein the main RF corresponds to a RF waveform applied to opposing electrode elements of the ion trap that cause the ion trap to produce a radial trapping field.

A1.6.1. The method of paragraph 1.6, wherein the electrode elements are rod sets, and the RF corresponds to the RF waveform applied to opposing rod sets of the ion trap that cause the ion trap to produce a radial trapping field.

A1.6.2. The method of any of paragraphs A1.6-A1.6.1, wherein the ion trap is a quadrupole linear ion trap, and the RF corresponds to the RF waveform applied to opposing electrode elements of the quadrupole linear ion trap that cause the ion trap to produce a radial quadrupolar trapping field.

A1.6.2.1. The method of paragraph 1.6, wherein when the RF waveform is applied to the opposing electrode elements, the quadrupole linear ion trap produces the radial quadrupolar trapping filed according to the Mathieu equation.

A1.7. The method of any of paragraphs A1-A1.6.2.1, wherein the auxiliary RF corresponds to a dipolar RF waveform applied to one set of opposing electrode elements.

A1.7.1. The method of paragraph 1.7, wherein, when the dipolar RF waveform is applied to the one set of opposing electrode elements, the ion trap produces a dipole electromagnetic field that induces radial dipolar excitation on ions within the ion trap.

A1.7.2. The method of any of paragraphs A1.7-A1.7.1, wherein the opposing electrode elements comprise one set of opposing electrode elements of the opposing electrode elements to which the RF waveform is applied.

A1.7.3. The method of any of paragraphs A1.7-A1.7.2, wherein the ion trap is a quadrupole linear ion trap, and the auxiliary RF corresponds to a dipolar RF waveform applied to one set of opposing electrode elements of the quadrupole linear ion trap that causes the generation of a dipole electromagnetic field that induces radial dipolar excitation on ions within the ion trap.

A1.8. The method of any of paragraphs A1-A1.7.3, wherein the resonance ejection frequency corresponds to the ion frequency at which radial excitation induced by the application of the auxiliary RF causes radial ion ejection from the ion trap.

A2. The method of any of paragraphs A1-A1.5.2, wherein causing the ion trap to perform a first scan out of ions corresponds to increasing the main RF until the magnitude of the voltages applied to the ion trap is within a threshold amount of a maximum magnitude voltage for the ion trap.

A2.1. The method of paragraph A2, wherein causing the ion trap to perform a first scan out of ions corresponds to increasing the main RF until the magnitude of the voltages applied to the ion trap is equal to the maximum magnitude voltage for the ion trap.

A3. The method of any of paragraphs A1-A2.1, wherein when the main RF applied to the ion trap is at the third value and the one or more new ejection parameters are set for the ion trap, the magnitude of the voltage applied to the ion trap is within a threshold amount of a maximum magnitude voltage for the ion trap.

A3.1. The method of paragraph A3, wherein when the main RF applied to the ion trap is at the third value and the one or more new ejection parameters are set for the ion trap, the magnitude of the voltage applied to the ion trap is equal to the maximum magnitude voltage for the ion trap.

A3.2. The method of any of paragraphs A1-A3.1, wherein the first RF value of the main RF is such that, while the initial ejection parameters are set for the ion trap, the maximum RF amplitude that can be applied to the ion trap would be exceeded if the main RF is scanned from the first RF value to the third RF value.

A4. The method of any of paragraphs A1-A3.2, wherein the first RF value corresponds to the main RF voltage that causes ions within the ion trap having a first Thompson value to resonate when the ion trap has the initial ejection parameters.

A4.1. The method of paragraph A4, wherein the second RF value corresponds to the main RF voltage that causes ions within the ion trap having a second Thompson value to resonate when the ion trap has the initial ejection parameters.

A4.2. The method of any of paragraphs A4-A4.1, wherein the third RF value corresponds to the main RF voltage that causes ions within ion trap having a third Thompson value to resonate when the ion trap has the new ejection parameters.

A4.3. The method of any of paragraphs A4-A4.2, wherein the fourth RF value corresponds to the main RF voltage that causes ions within the ion trap having a fourth Thompson value to resonate when the linear ion trap has the new ejection parameters.

A4.4. The method of any of paragraphs A4-A4.3, wherein the second Thompson value is greater than the first Thompson value.

A4.5. The method of any of paragraphs A4-A4.4, wherein the third Thompson value is greater than the fourth Thompson value.

A4.6. The method of any of paragraphs A4-A4.6, wherein the third Thompson value is greater than each of the first Thompson value and the second Thompson value.

A4.7. The method of any of paragraphs A4-A4.6, wherein the fourth Thompson value is greater than the first Thompson value.

A4.8. The method of any of paragraphs A4-A4.7, wherein the fourth Thompson value is equal to the second Thompson value.

A5. The method of any of paragraphs A1-A4.8, further comprising filling the ion trap with a plurality of ions.

A5.1. The method of paragraph A5, wherein the plurality of ions includes ions of different Thompson values.

A5.1.1. The method of paragraph A5.1, wherein the plurality of ions includes ions within the range between first Thompson value to the third Thompson value.

A5.2. The method of any of paragraphs A5-A5.1.1, further including generating the plurality of ions via an ion source.

A5.2.1. The method of paragraph 5.2, further including guiding the plurality of ions from the ion source and into the ion trap.

A5.2.1.1. The method of paragraph 5.2.1, further comprising allowing the plurality of ions to enter the plurality of ions into the ion trap for a loading time period.

A5.2.1.2. The method of paragraph 5.2.1.1, further comprising stopping the flow of ions into the ion trap at the end of the loading time period.

A5.2.1.3. The method of paragraph 5.2.1.2, wherein no additional ions are allowed to enter the ion trap after the loading time period.

A6. The method of any of paragraphs A1-A5.2.1.3, wherein when individual ions within the ion trap come into resonance they are ejected from the ion trap.

A6.0. The method of paragraph A6, wherein when the individual ions within the ion trap come into resonance with the resonance ejection frequency they are ejected from the ion trap.

A6.1. The method of any of paragraphs A6-A6.0, wherein during the performance of the first scan, ions of increasing Thompson value are ejected over the course of the performance of the first scan.

A6.2. The method of any of paragraphs A6-A6.1, wherein during the performance of the second scan, ions of decreasing Thompson value are ejected over the course of the performance of the second scan.

A6.3. The method of any of paragraphs A6-A6.3, wherein at least a portion of the ions that are ejected from the ion trap are detected by a detector system.

A6.3.1. The method of paragraph A63, wherein individual ions that are ejected from the ion trap are incident on a detection surface of a detector system.

A6.3.2. The method of any of paragraphs A6.3-A6.3.1, further comprising generating first detection data that describes the ions detected by the detector system during the first scan and second detection data that describes the ions detected by the detector system during the second scan.

A7. The method of any of paragraphs A1-A6.3.1, further comprising estimating a quantity of ions in the ion trap based on the first detection data and the second detection data.

A7.1. The method of paragraph A7, wherein estimating the quantity of ions ion in the ion trap comprises scaling the incidents of ions being detected by the detector system.

A7.2. The method of any of paragraphs A7-A7.1, wherein estimating the quantity of ions in the ion the ion trap comprises: applying one or more first weights to the first detection data from the first scan; and applying one or more second weights to the second detection data from the second scan.

A7.2.1. The method of paragraph 7.2, wherein the one or more first weights are different from the one or more second weights.

A7.2.2. The method of any of paragraphs A7.2-A7.2.1, wherein the first weight is derived using one or more of an experimental derivation of ejection efficiency, formulaic derivation of expected ejection efficiencies, and modeling of the expected performance of the ion trap.

A7.2.3. The method of any of paragraphs A7.2-A7.2.2, wherein the second weight is derived using one or more of an experimental derivation of ejection efficiency, formulaic derivation of expected ejection efficiencies, and modeling of the expected performance of the ion trap.

A7.2.4. The method of any of paragraphs A7.2-A7.2.3, wherein the first weights correspond to expected ejection efficiencies for ions ejected in the first scan.

A7.2.5. The method of any of paragraphs A7.2-A7.2.4, wherein second weights correspond to expected ejection efficiencies for ions ejected in the second scan.

A7.2.6. The method of any of paragraphs A7.2-A7.2.5, wherein the one or more first weights and the one or more second weights at least partially correspond to the efficiency that ions ejected from the ion trap of a corresponding Thompson value are expected to be detected by the detector system during the first scan and the second scan, respectively.

A8. The method of any of paragraphs A1-A7.2.6, further comprising determining a rate of injection that ions were introduced into the ion trap during loading.

A8.1. The method of paragraph A8, wherein determining the rate of injection corresponds to dividing the estimated quantity of ions in the ion trap by the loading time period that ions were allowed to enter the ion trap.

A9. The method of any of paragraphs A1-A8.1, wherein increasing the amplitude of the auxiliary RF causes the potential well depths for ions in the ion containment area to be increased.

A10. The method of any of paragraphs A1-A9, further comprising: setting one or more additional ejection parameters for the ion trap, wherein setting the one or more additional ejection parameters comprises changing the auxiliary RF applied to the ion trap to a third auxiliary value; and causing the ion trap to perform a third scan out of ions.

A10.1. The method of paragraph A10, further comprising repeating the steps of paragraph A10 to conduct one or more additional scans.

A11. The method of any of paragraphs A1-A10.1, wherein the ion trap is a linear ion trap.

A11.0. The method of any of paragraphs A1-A11, wherein the ion trap is a quadrupole ion trap.

A11.1. The method of paragraph A11, wherein the linear ion trap is a 2-D ion trap.

A11.2. The method of paragraph A11, wherein the linear ion trap is a 3-D ion trap.

A11.3. The method of any of paragraphs A11-A11.1, wherein the linear ion trap comprises an array of four linear electrodes that surround an ion containment area about a z-axis.

A11.3.1. The method of paragraphs A11.3, wherein one or more of the linear electrodes are composed of multiple segments.

A11.3.2. The method of any of paragraphs A11-A11.3.1, wherein ions may be contained within a radial distance of the z-axis in an ion containment area at least in part by two-dimensional RF fields (i.e., in the x or y plane) generated by RF voltages applied to the four linear electrodes.

A11.3.3. The method of any of paragraphs A11-A11.3.2, wherein the four linear electrodes comprise a first pair of electrodes that have first RF voltages applied to them that are in phase, and a second pair of electrodes that have second RF voltages applied to them that are in phase, wherein the first RF voltages are not in phase with the second RF voltages.

A11.3.4. The method of any of paragraphs A11-A11.3.3, wherein the linear ion trap further comprises two end cap electrodes positioned along the z-axis of the linear ion trap.

A11.3.4.1. The method of paragraph A11.3.4, wherein the four linear electrodes that surround the ion containment area about the z-axis are positioned between the two end cap electrodes.

A11.3.4.2. The method of any of paragraphs A11.3.4-A11.3.4.1, wherein the ion containment area is located between the two end cap electrodes.

A11.3.4.3. The method of any of paragraphs A11.3.4-A11.3.4.2, wherein a DC potential applied to the two end caps causes the end cap electrodes to generate electromagnetic fields.

A11.3.4.4. The method of any of paragraphs A11.3.4-A11.3.4.3, wherein ions may be contained within the ion containment area at least in part by the electromagnetic fields generated by the end cap electrodes.

A11.3.5. The method of any of paragraphs A11.3-A11.3.4.4, wherein at least one of the electrodes comprises an aperture, the aperture being configured to allows ions which have achieved resonance to pass from the ion containment area to a detector by passing through the aperture.

A12. The method of any of paragraphs A1-A11.3.5, wherein the method is part of a pre-scan process for a subsequent experiment.

A12.1. The method of paragraph A12, wherein the subsequent experiment comprises loading a desired quantity of new ions into the ion trap, and performing mass spec analysis on the new ions subsequently loaded into the ion trap.

A12.2. The method of paragraph A12, wherein the subsequent experiment comprises loading a desired quantity of new ions into an additional ion trap that is different from the ion trap, and performing mass spec analysis on the new ions subsequently loaded into the additional ion trap.

A12.2.1. The method of paragraph A12.2, wherein the additional ion trap is at least one of: a 3D ion trap; a 2D linear ion trap; a quadrupole ion trap; a Kingdom ion trap; an Orbitrap; and any other type of ion trap configured to store a population of ions prior to mass analysis in a time of flight mass spectrometer.

A12.3. The method of any of paragraphs A12-A12.2.1, wherein loading the desired quantity of new ions comprises using the determined rate of injection.

A12.3.1. The method of paragraph A12.3, wherein loading the desired quantity comprises: determining a loading duration that is required to load the desired quantity of ions when they are loaded at the rate of injection; and allowing ions to be injected for the loading duration.

B1. A method for performing a pre-scan to load an ion trap with an optimal quantity of ions, the method comprising: determining a rate of injection using a pre-scan ion trap according to the method of paragraphs A8 or A8.1; loading the optimal quantity of ions into the ion trap; and performing a mass spec analysis on the optimal quantity of ions in the ion trap.

B2. The method of paragraphs B1, wherein loading the optimal quantity of ions into the ion trap comprises: determining a loading duration that is required to load the desired quantity of ions when they are loaded at the rate of injection; and allowing ions to be injected for the loading duration.

C1. An ion trap having increased mass range with reduced mass discrimination, the ion trap comprising: an array of four linear electrodes that surround an ion containment area about a z-axis; two end cap electrodes positioned along the z-axis of the linear ion trap, wherein the four linear electrodes that surround the ion containment area about the z-axis are positioned between the two end cap electrodes; and one or more voltage sources configured to provide at least a main RF and an auxiliary RF to the ion trap.

C2. The ion trap of paragraph C1, further comprising: a processor; and a memory storing executable instructions that, when executed on the processor, cause the ion trap to perform the method of any of paragraphs A1-A12.3.1 or B1-B2.

D1. A mass spectrometer that includes an ion trap having increased mass range with reduced mass discrimination, the mass spectrometer comprising: an ion source configured to generate a plurality of ions; the ion trap of paragraphs C1 or C2; a detector system configured to detect at least ions ejected from the ion trap; a processor; and a memory storing executable instructions that, when executed on the processor, cause the ion trap to perform the method of any of paragraphs A1-A12.3.1 or B1-B2.

D2. The mas s spectrometer of paragraph D1, further comprising an additional ion trap of the subsequent experiment.

E1. Use of the ion trap of paragraphs C1 or C2 to perform the method of any of paragraphs A1-A12.3.1 or B1-B2.

F1. Use of the mass spectrometer of paragraphs D1 or D2 to perform the method of any of paragraphs A1-A12.3.1 or B1-B2.

Gl. Non-transitory computer readable instructions that, when executed on a processor, cause the processor in initiate performance of the method of any of paragraphs A1-A12.3.1 or B1-B2.

What is claimed:

1. An ion trap having increased mass range with reduced mass discrimination, the ion trap comprising:
an array of four linear electrodes that surround an ion containment area about a z-axis;
two end cap electrodes positioned along the z-axis of the linear ion trap, wherein the four linear electrodes that surround the ion containment area about the z-axis are positioned between the two end cap electrodes; and
one or more voltage sources configured to provide at least a main RF and an auxiliary RF to the ion trap; and
wherein the ion trap is communicatively coupled to a processor and a memory storing executable media that, when executed on the processor, cause the ion trap to:
cause the ion trap to perform a first scan out of ions by systematically increasing a main RF voltage applied to the ion trap from a first RF value to a second RF value; and
cause the ion trap to perform a second scan out of ions by systematically decreasing the main RF voltage applied to the ion trap from a third RF value to a fourth RF value.

2. The ion trap of claim 1, wherein the media, when executed on the processor, further cause the ion trap to:
before the first scan is performed, set one or more initial ejection parameters for the ion trap; and
between the performance of the first scan and the second scan, set one or more new ejection parameters for the ion trap, wherein setting the one or more ejection parameters comprises applying an auxiliary RF of a first auxiliary value to the ion trap.

3. The ion trap of claim 1, wherein the media, when executed on the processor, further cause the ion trap to:
determining a rate of injection that ions were introduced into the ion trap during loading by dividing the estimated quantity of ions in the ion trap by the loading time period that ions were allowed to enter the ion trap;
loading an optimal quantity of ions into the ion trap for a desired experiment; and
performing a mass spec analysis on the optimal quantity of ions in the ion trap.

4. The ion trap of claim 3, wherein loading the optimal quantity of ions into the ion trap comprises:
determining a loading duration that is required to load the desired quantity of ions when they are loaded at the rate of injection; and
allowing ions to be injected for the loading duration.

5. A mass spectrometer that includes an ion trap having increased mass range with reduced mass discrimination, the mass spectrometer comprising:
an ion source configured to generate a plurality of ions;
the ion trap of claim 1; and
a detector system configured to detect at least ions ejected from the ion trap.

6. Non-transitory computer readable media that, when executed on a processor, cause the processor in initiate performance of, the method comprising:
causing the ion trap to perform a first scan out of ions by systematically increasing a main RF voltage applied to the ion trap from a first RF value to a second RF value; and
causing the ion trap to perform a second scan out of ions by systematically decreasing the main RF voltage applied to the ion trap from a third RF value to a fourth RF value.

7. The non-transitory computer readable media of claim 5, wherein the media, when executed on the processor, further causes:
before the first scan is performed, setting one or more initial ejection parameters for the ion trap; and
between the performance of the first scan and the second scan, setting one or more new ejection parameters for the ion trap, wherein setting the one or more ejection parameters comprises applying an auxiliary RF of a first auxiliary value to the ion trap.

8. The non-transitory computer readable media of claim 5, wherein the second RF value is greater than the first RF value, and wherein the third RF value is greater than the first RF fourth.

9. The non-transitory computer readable media of claim 5, wherein the second RF value corresponds to greater than 75% of the maximum of main RF voltage the ion trap can handle, and the third RF value corresponds to greater than 75% of the maximum of main RF voltage the ion trap can handle.

10. The non-transitory computer readable media of claim 5, wherein the r0, the maximum main RF voltage, and main RF frequency of the ion trap are not changed between the first scan and the second scan, wherein the resonance ejection frequency is a first frequency value during the first scan out and a second frequency value during the second scan out, and wherein the first frequency value is greater than the second frequency value.

11. The non-transitory computer readable media of claim 10, wherein the first frequency value and the second frequency value are determined or otherwise selected such that ions having a first desired Thompson value are ejected from the ion trap during the first scan out and ions having a second desired Thompson value are ejected from the ion trap during the second scan out.

12. The non-transitory computer readable media of claim 5, wherein the first scan out of ions and the second scan out of ions are each performed on a population of ions injected during a single ion injection cycle, and wherein the single ion injection cycle comprises:
allowing the population of ions to pass into the ion trap;
closing the ion trap so as to contain the population of ions in the ion trap.

13. The non-transitory computer readable media of claim 12, wherein n no additional ions are injected or otherwise intentionally introduced into the ion trap between the first scan out of ions and the second scan out of ions.

14. The non-transitory computer readable media of claim 5, wherein causing the ion trap to perform a first scan out of ions corresponds to increasing the main RF until the magnitude of the voltages applied to the ion trap is within a threshold amount of a maximum magnitude voltage for the ion trap.

15. The non-transitory computer readable media of claim 5, wherein when the main RF applied to the ion trap is at the third value and the one or more new ejection parameters are set for the ion trap, the magnitude of the voltage applied to the ion trap is within a threshold amount of a maximum magnitude voltage for the ion trap.

16. The non-transitory computer readable media of claim 5, wherein the first RF value of the main RF is such that, while the initial ejection parameters are set for the ion trap, the maximum RF amplitude that can be applied to the ion trap would be exceeded if the main RF is scanned from the first RF value to the third RF value.

17. The non-transitory computer readable media of claim 5, wherein the first RF value corresponds to the main RF voltage that causes ions within the ion trap having a first Thompson value to resonate when the ion trap has the initial ejection parameters, wherein the second RF value corresponds to the main RF voltage that causes ions within the ion trap having a second Thompson value to resonate when the ion trap has the initial ejection parameters, and wherein the second Thompson value is greater than the first Thompson value.

18. The non-transitory computer readable media of claim 17, wherein the third RF value corresponds to the main RF voltage that causes ions within ion trap having a third Thompson value to resonate when the ion trap has the new ejection parameters, wherein the fourth RF value corresponds to the main RF voltage that causes ions within the ion trap having a fourth Thompson value to resonate when the linear ion trap has the new ejection parameters, wherein the third Thompson value is greater than the fourth Thompson value.

19. The non-transitory computer readable media of claim 5, wherein the media, when executed on the processor, further causes estimating a quantity of ions in the ion trap based on the first detection data and the second detection data by:
applying one or more first weights to the first detection data from the first scan; and
applying one or more second weights to the second detection data from the second scan.

20. The non-transitory computer readable media of claim 5, wherein the media, when executed on the processor, further causes:
setting one or more additional ejection parameters for the ion trap, wherein setting the one or more additional ejection parameters comprises changing the auxiliary RF applied to the ion trap to a third auxiliary value; and
causing the ion trap to perform a third scan out of ions.
